(19) United States
(12) Patent Application Publication
(10) Pub. No.: US 2005/0138081 A1
(43) Pub. Date: Jun. 23, 2005

(54) Method and system for reducing information latency in a business enterprise

(76) Inventors: Melanie A. Alshab, Indianapolis, IN (US); Peter J. Bales, St. Peters, MO (US); Robert D. Covington, Indianapolis, IN (US); Richard A. Sampson, Indianapolis, IN (US); Lisa M. Trotter, Fishers, IN (US)

Correspondence Address: BAKER & DANIELS, 300 NORTH MERIDIAN STREET, SUITE 2700, INDIANAPOLIS, IN, 46204-1782, US

(21) Appl. No.: 10/844,209

(22) Filed: May 12, 2004

Related U.S. Application Data
(60) Provisional application No. 60/470,758, filed on May 14, 2003.

(51) Int. Cl. G06F 17/60; G06F 12/00; G06F 17/30

(52) U.S. Cl. 707/200; 705/1

(57) ABSTRACT

The present invention involves a method of reducing information latency in a business enterprise having a computer system. The method includes the steps of accessing a data source and obtaining transaction information relating to changes in the data source. The data source contains data instances and meta data. A change in either a data instance or a meta data may activate an event within the computer system. The method includes determining whether a response is necessary to an event initiated by a change in the data source. The method also includes determining if the change in the data source was the result of access within or external to an application.

### BACKGROUND OF THE INVENTION

1. Field of the Invention

The invention relates to event-driven systems. Specifically, the field of the invention is the real-time detection of and response to changes in a business environment through the detection of changes in a database, file, or stream of data through a communication system in order to reduce information latency in a business enterprise.

2. Description of the Related Art

Business Networks evolve continuously, involving methods, transports, and Systems used by participants within and between Value Networks. A “Value Network” is a loosely or tightly coupled group of entities involved in producing and/or providing a product or service. Business Networks, in addition to the relevant business conditions of the time, establish the means, objectives and requirements of interaction within and between enterprises. “Systems” are any tool utilized to conduct business including processes, data, information flow, or technological devices. Today's business environment requires moving beyond the boundaries of the enterprise, in order to actively drive and influence activities across the entire value chain.

In the 1970s, enterprises began computing in a centralized model. Taking manual processes and turning them into automated processes achieved major benefits. While achieving significant benefits through automation, processes were usually executed in batch mode, and days would often pass before reports could be distributed to decision makers. In addition, programmers were required not only to develop new reports, but often to run the reports once they had been programmed. This resulted in significant latency in Business Networks, as there was a large time lag between information availability and the Business Events themselves. “Business Events” are a condition or set of conditions within or between Business Networks which may or may not require a response. The requirement for integration was minimal as the applications themselves were typically on a single platform and comparatively simplistic in their design.

With the advent of the personal computer, the 1980s brought distributed computing. Information could now be downloaded from the centralized systems and processed locally. Spreadsheets and local databases allowed individuals to process their own information, which was both a huge advantage and disadvantage. This resulted in information islands within the enterprise where information was not distributed to all needed stakeholders-everyone had their own spreadsheet and synchronizing them was next to impossible.

Network applications developed in the 1990s, with the emphasis on sharing data within shared applications. These applications created information silos for specific types of information. Client Server based Enterprise Resource Planning (ERP) systems provided financial information. Customer Relationship Management (CRM) systems maintained customer data. These information silos allowed users to access information locally, yet provided centralized processing, which reduced the problem of desktop information islands.

Enterprises adopted multiple business application architectures; each designed to bring efficiency and effectiveness to specific areas of the business (i.e. supply chain management, customer relationship management, employee relationship management). These applications within an enterprise came from different vendors and required different platforms (and more capital investment) to operate and maintain. For a business to operate effectively, these systems then had to be linked to enterprise-wide processes to function. Furthermore, these applications also needed to interact with partners and customer systems in order to execute inter-enterprise business processes. Information silos were integrated within their own application, but restrictive in terms of inter-application, business unit and process flexibility.

Initially, bridges between business applications were ‘hard coded’—a tedious and expensive task. Further, this single use code further reduced flexibility within the local business environment and many business leaders resisted this approach fearing a loss of autonomy and flexibility. This static architecture was at odds with the growing realization that while enterprises must synchronize their processes, businesses must also retain their flexibility.

In the late 1990s and early 2000s, Enterprise Application Integration (EAI) solutions became available to integrate these application silos. They were expensive to implement—requiring all parties involved with the integration to once again agree on a series of technical standards—which within some organizations was not realistic either inside or outside of the firewall.

Further, once implemented, EIA solutions impeded rather than enhanced process flexibility and business adaptability. Data warehousing tools were also implemented to glean insight into future trends or paradigms of the past, both across and between these data silos. However, the very nature of these tools necessitated moving huge amounts of data and re-sorting this data in a predetermined fashion and in batch mode, because there was no way to determine exactly what “pieces” of data should be updated. As a result, every piece of data is updated, regardless of whether it changed since the last update or not—a very time consuming process and one that requires significant computer and network resources. Often businesses discovered that by the time they had the answer, the question had already changed.

In order to increase value across and between trading partners, organizations have made connections with other entities in their Value Networks. Additionally, there are an increased number of individuals with the technical skill and know-how required to access these systems. This has significantly increased the potential and sometimes the requirement for information to be modified outside of an application. Security of information is almost always controlled by the application. In those instances where information is also “secured” outside of the application, individuals performing routine tasks are often required to have access to this information. Detecting the individual source or user of data changes within an application is more controlled than the detection of the individual source or user of data changes outside of the application, thus exposing the organization to unknown threats related to data tampering. For this reason, data tampering Business Events often go undetected by an organization until the adverse affects are already in motion.

To achieve a real-time low latency business environment without an event-driven system would require either an army of clerks poring over reports or delving into systems using random spot-checks. Both of these approaches result in some number of undetected events, any one of which could have a detrimental impact on the enterprise.

### SUMMARY OF THE INVENTION

In a Business Network architected for federation, tight integration gives way to an architecture that is loosely coupled and modular. This federated architecture supports Business Events and processes that can be dynamically tailored to the needs of specific products, customers, or both. A federated approach makes sense in those instances where discrete elements of information must be identified and connected, and when a certain set of circumstances occur which define an exceptional event. This approach provides the ability to retain flexibility, and to iteratively derive and implement loosely coupled processes based on Business Events rather than ‘hard bolted’ processes based on a predefined workflow. This achieves a dynamic synchronization between business units, partners, processes, applications, and networks rather than a static idealized homogenization of these entities and platforms. The present invention provides federation among relevant entities, activation of relevant responses, process ‘self sufficiency’ from application silos and technical architectures, the real-time ability to detect discrete changes in a database or file and the complete accountability of data.

Today, businesses realize that integration is costly and necessary, but that a ‘one size fits all’ approach is unrealistic. In some, but not all circumstances, ‘full’ integration is not necessary, and a more flexible federated approach is preferable. If, after all, the requirement to integrate between information and event silos exists in order to detect if certain business conditions occur, full integration may in fact impede the detection of these circumstances based on the complexity of the integration application itself.

Previous enterprise implementations have had the net effect of creating information and event islands, which usually require a trade-off between integration and flexibility. However, the requirement to be aware of Business Events quickly and, once aware, the ability of a business to react and implement a solution to these conditions is increasing. Businesses must be able to identify significant Business Events and adapt in real-time to either derive benefit from an event or to decrease the undesirable impact. This process of change is iterative and its very nature requires not one large response, but several coordinated individual responses, with the ability to ‘tweak’ or adapt along the way.

Traditionally, connectivity between applications required a tight integration. The present invention loosely couples Systems, which are dynamically accessed across multiple entities and diverse technology platforms. This ‘loose coupling’ means that the connections can be established without being tailored to the specific functionality embedded in applications. This approach honors the diversity of current computing platforms, unique requirements of each business, and applications that evolved within and across the business. The past methods of tightly integrating resources evolved into a coalition of platforms and applications. The ‘federation’ of all resources in the enterprise, in paradox to past technology design, is key to managing complexity without limiting the flexibility and openness of the underlying Business Network.

The present invention also provides this real and true federated functionality. The invention monitors all Systems, detects discrete changes in the Business Network, identifies those conditions which meet certain criteria or are exceptional (including data tampering outside an application), and activates the appropriate response. This functionality is enabled in real-time, or in a user specified interval, with little or no lag or ‘latency’ between the occurrence of the event and the activation of the response, whether the response is a pager alarm to a manager, a brokerage sell order, a production line increase of a certain product, an update of a business dashboard to announce that certain goals are slipping below acceptable levels, an alert that certain corporate governance flags have been triggered, or any other response that is appropriate for the Business Network. The present invention is a ‘wrapper’ application that can envelope any architecture or several disparate architectures. As a result, it is virtually non-invasive to technology infrastructures and applications, and does not require extensive modifications for integration or lengthy implementations for real returns to be delivered. The present invention releases the latent value of existing information technology (IT) investments, and allows a business to detect, identify and respond to opportunities and threats in real-time. It enables a flexible, iterative and adaptive business architecture where ‘getting it perfect’ the first time is less important than being able to improve quickly, effectively and in real-time.

The present invention detects discrete changes in business information such as those stored in a database, file, or presented in a communication stream, and it is also able to detect if the changes were made by a user or process accessing an application utilizing the application's normal access modes or if the access to the application was made outside the application's control. Such detection is critical to understanding data tampering Business Events, which may have compliance or fraud implications.

The present invention federates and synchronizes information from multiple applications, as well as data from other internal and external sources. The invention supports storing a result set cache for storing the result of business queries, and the invention automatically voids a specific query result set when the underlying data or data meta data for that specific query has changed. This eliminates the requirement to “expire” or update every query result set “en masse” so that the outdated result sets are purged. Queries can be presented to the invention that span multiple information sources which will automatically query the independent information sources of the query and join the resultant information together into a single unified result set. These queries may utilize results from the result set cache to improve performance.

The present invention delivers knowledge of significant Business Events when they occur in the enterprise so that effective action can be taken to respond to those Business Events. The invention enables an agile real-time enterprise, i.e., a business immediately aware of change rather than a reactive business stuck with constantly fire-fighting unexpected Business Events retroactively, or retrofitting the business strategy in order to match it to the Business Events of the past that have only now come to light. An event driven enterprise can instantly sense and respond to Business Events that enhance value and mitigate risk.

The present invention monitors, detects, identifies and responds to changes in the business environment. Most importantly, these functions occur in real-time with little or no latency. The invention includes the following functions: (1) monitor enterprise systems and federate actions in order to synchronize business activity, thereby providing a real-time landscape of changes in the business environment; (2) detect relevant and discrete information changes; (3) identify business events by comparing changes in information to condition associated with the known event.

The present invention involves a method of and computer system for reducing information latency, federating Systems, and responding to Business Events in a business enterprise. The method is embodied in software suitable for use on a computer system including a data source storing data instances, files, and data meta data. The data source provides information indicating all transactions occurring in the data source, including changes made to data instances, file, and/or meta data. A change in either a data instance, file, or meta data may initiate an event within the computer system. The method embodied by the software includes the steps of accessing the data source and obtaining transaction information relating to changes in the data source, and also determining based on the transaction information if a response to an initiated event is necessary.

In another form of the present invention, a computer system in which the above-described software-embodied method may be implemented is provided. The computer system includes a communications network, a plurality of data sources coupled to the communications network and a server coupled to the communications network. The server is in communication with the plurality of data sources, and at least one of the plurality of data sources stores data in a meta data different than at least one of the other ones of the plurality of data sources. A computer coupled to the communications network includes a query system for enabling a query to the server relating to the data stored in any of the plurality of data sources.

Another aspect of the invention relates to a non-invasive and discrete enterprise “sensing” technology for the broadest range of information sources in the enterprise. The present invention monitors and collects very small changes in both data and meta data, from each information source in the organization, in real-time using a native event driven approach. Using a variety of technologies—including packet capture—to “sense” any changes as they occur, both file and transaction tampering may be detected.

The present invention may be configured to provide the most comprehensive and practical solution for real-time information protection and archiving, tamper detection and automatic recovery, and information retrieval. Event-Driven Information Lifecycle Management Automated provides several advantages: Real-Time Backup, Any-Point-In-Time Data Recovery, Tamper Detection and Protection, and Revision Control Management.

The present invention may deal with e-mail, CAD files, digital check images, log files, video files, Word documents, instant messages, radiology scans, general ledger, and sensitive customer records in a dozen databases. It's an ever-increasing deluge of structured and unstructured information that spans from desktop to data center.

Facing new mandates to store and manage that data to comply with requirements of Sarbanes-Oxley, HIPAA, SEC 17a-4, the Patriot Act, Basel II, and other regulations, the bar is being raised for data visibility and retrievability. The present invetnion is engineered explicitly to give information managers a potent weapon in the battle against information overload and the drive towards regulatory compliance. The invention provides new and better solutions for real-time (i) data backup, archiving, and recovery, (ii) tamper detection and protection, and (iii) revision control management.

The invention may be broadly applied for any industry in which data accountability, auditing and regulatory compliance is required. Built on open standards, such as Java and the like, it provides a records management platform that enables enterprises to confidently manage, store and retrieve any type of information or content, as well as meet strict legal requirements.

The U.S. SEC, for instance, now requires certain companies to store email for 20 years—and make those records accessible within 24 hours. The present invention is designed to provide that magnitude of archiving and recovery.

An event may be a customer order, a bank withdrawal, or a click on a Web page. The present invention's event-detection technology to the granular information layer, so that any changed data is automatically identified and archived. With a rich set of features and functionality, the present invention is well suited for the information management challenges facing today's enterprise.

Real-Time Backup: Using event-driven technology, ZOMA DataVault provides real-time, 24/7 data backup of most enterprise information sources including files, emails, instant messages, log files, router configuration files, and SOAP message streams.

Noninvasive Monitor Technology: the invention may monitor changes in most enterprise data sources with little or no changes to the information source monitored. The event detection engine identifies granular changes in block-level data and automatically executes updates to your storage environment. This unique approach ensures that archived data is always accurate and up-to-date, and eliminates downtime required for nightly backups.

Any-Point-In-Time Recovery: With its versioning and revision control management technology, the invention enables one to zero in on information as it existed at any given point in time. Word documents, digital video, databases, financial statements, or emails from Jul. 14, 2001, are readily retrievable—an indispensable feature for auditing and compliance with Sarbanes-Oxley and other regulations.

Transparent Index Management: the invention eliminates the need to build and maintain complex information indexes that are often prone to failure and “breakage.” Backup and recovery is based on sequential storage techniques eliminating the need for complex indexing; instead, an efficient transparent index management layer is provided to support records search. Indexes are not required for restoring data.

Changed Data Capture & Compression: the system of the invention intelligently captures only data that is changed for real-time backup, reducing data volume and bandwidth overhead by orders of magnitude. This methodology further reduces data volume by a factor of 2 to 8 times.

Application Tamper and Access Detection: the event monitoring technology—when used with the event initiator—provides integrated, automated tamper detection to safeguard against unauthorized records and file access and manipulation of application information, be it malicious or inadvertent. If tampering is detected, the change is stored as a tampered version in the Archive, and the last known non-tampered version can be automatically restored. E-mail can also be sent to alert appropriate personnel of the event.

Comprehensive Content Addressable Storage: the invention's advanced Comprehensive Content Addressable Storage (CCAS) architecture efficiently retrieves all relevant archived information (files, emails, IM's) based on the content and/or type of information archived. This feature significantly reduces the cost and time required to comply with legal and regulatory discovery requests and retrieval requests in general.

Fixed Virtual Storage: the inventive system uses sophisticated virtual fixed storage technology that assigns each archived record a unique identification address generated by a hashing algorithm. Like a digital DNA, the object-oriented technology ensures that archived records are treated as non-rewritable, non-erasable “fixed content” that cannot be altered or duplicated—a distinction crucial to data integrity and auditability.

Future Proofed Recovery: with standards-based archiving protocols, media independence and transparent index management enable recovery periods of decades rather than years. This “engine independent” recovery capability elegantly and efficiently meets today's long-term regulatory archiving requirements while providing assurance of recovery for the future.

Data Coalescence: Aimed at reducing disk space and storage costs, the Archive Server features technology known as data coalescence to intelligently discern and manage multiple, but identical, versions of the same record. In a practical sense, this means that the same Word document forwarded in a dozen emails is stored only once—not 12 times. Minimizing or eliminating data redundancy can easily cut disk usage in half.

Unmatched Flexibility, Accountability, and Reach: Information management problems can be complex. By being built on open standards, this platform-independent solution is virtually transparent to both network and administrator. With its easy to use Management Console, storage process automation, and robust search and retrieval capabilities, the inventive system provides a secure and cost-effective solution to the most daunting information management challenge.

The inventive system provides a fast, flexible management of virtually any information—database records and schema changes, application transactions, emails, router configurations, medical images, CAD/CAM designs, check and document media, word processing documents, and more. The Archive Server's extensibility allows for deployment for a discrete application, such as email archiving, or extention across a distributed global environment of heterogeneous resources.

Platform and Hardware Agnostic: Java-based ZOMA DataVault server and monitors universally support nearly all platforms, including Microsoft Windows, HP-UX, Macintosh, AIX, Solaris, and Linux. Its native clustering and storage management supports fault-tolerant backup and recovery on virtually any platform, with seamless integration with leading SAN (Storage Area Network) and NAS (Network Attached Storage) platforms and relational databases. Its low I/O duty cycles mean that you can use low-cost hardware.

Any Source, Any Data, Any Target: Covering servers, PCs, and laptops, the Archive Server provides information event-detection and backup for practically any type of information in any system—files, database transactions, logs, emails, instant messages, SOAP (Simple Object Access Protocol) messages, message queues, HTTP (HyperText Transport Protocol), Web content, and operating system data. J2EE compliance and support for XML help ensure its integration with most infrastructures.

Minimal Impact with Non-Invasive Monitors: the event-detection Monitors run in the background with negligible or no impact on client or systems performance, and no use of invasive database triggers. With the Monitors monitoring changes in real-time, large-scale nightly backup windows are not required.

Ease of Administration: For IT administrators, the system supplies an intuitive, management console—a single point of control over a range of systems and processes. An automatic backup of transaction logs supplies a granular record of activity, and task automation and policy-based administration helps to simplify management and reduce administrative workloads.

Visibility with Integrated Meta Data: the Archive Server automatically populates and maintains a meta data archive that gives administrators a view into “data about data,” with full lineage, versioning, and cross-referencing across vast information sets. Two-way meta data transparency and content certificate generation deliver visibility and assurance of the information history and integrity.

Defer Platform Upgrades: the real-time non-invasive archiving of the present invention may result in better performance of file and application database servers including email databases. Thus platform upgrades can be deferred and service level agreement objectives are more easily met.

Peace of Mind: Encrypted Secure Transport: the invention eliminates concern over security of data either in-transit or in an archived state with zSTP (secure transfer protocol). This TCP/IP (Transmission Control Protocol/Internet Protocol) technology provides full encryption and an exceptionally high degree of protection against unauthorized access to sensitive information.

The present invention may be implemented in an application service provider (ASP) mode, as an installed and integrated system component, or as a combination. The ASP model minimizes IT deployment and administration investment within an organization, while providing automated registration and recovery services. Customer information access is protected with a unique encryption key that ensures data is protected both in-transit and in storage.

The event initiator integrates seamlessly as a second module in the invention, and provides a Complex Event Processing (CEP) framework. The full set of features of the invention provides robust federation of distributed enterprise data, and an asynchronous, real-time “monitor, collect, detect, identify, and respond” framework that alerts users to changed business conditions, and automates process changes and responses.

The invention further provides a new Archive Server that provides a solution to successfully address the information management, archiving and regulatory data compliance issues facing today's organization. ZOMA DataVault is comprised of and employs various technologies to fulfill the promise of Event-Driven Architecture. In its simplest configuration, an Archive Server and File Monitor provide the basic functionality. Additional Monitors may be added easily and quickly.

Archive Server: The Archive Server communicates with and accepts data streams from all Monitors utilizing the industry standard ASN.1 protocol. The Archive Server stores the data in the appropriate format and responds to requests from Monitors and the Management Console, including performing search and export functions. In addition, the Archive Server performs a number of routine tasks, such a tamper detection of the archive, usage reporting and other maintenance functions. The Archive Server is natively architected on an Event-Driven Architecture which uniquely enables processing of “complex events” through the event initiator, an optional module.

File Monitor: The File Monitor detects in real-time (or at any-point-in time, as scheduled) changes to files within a monitored file structure. When changes are detected, the File Monitor compares the changed file to the last previous generated fingerprint, on a block by block basis, to determine the correct incremental blocks that have changed. The File Monitor also provides the communication to the Archive Server and both compresses and encrypts the data transfer stream.

Changes detected include: •new file, •modified files, •deleted files, •optional file tamper detection. Monitors may provide additional archiving functionality. For example, both Email and Instant Message (IM) Monitors are available and are highly scalable to meet the archiving requirements of any enterprise.

Email Monitor: The Email Monitor detects and captures new emails as they are transmitted across a network. The captured email is sent to the Archive Server with all collected meta data and stored in a searchable, XML-exportable database. The Email Monitor operates in real-time to assure proper data collection, identification and the proper archival response. Not only are enterprise-level email applications supported and archived, but also SMTP (Simple Mail Transfer Protocol) and POP3 (Post Office Protocol 3) email is also archived. Email Servers include: •Exchange, •Lotus Notes, •SMTP/POP 3 monitoring through network packet capture technology.

Instant Messaging (IM) Monitor: The Instant Messaging Monitor is positioned in the enterprise to collect and archive any IM communication transmitted across the network. The Archive server stores these messages in a searchable, XML-exportable database. The IM Monitor operates in real-time to assure proper data collection, identification and the proper archival response. Various types of messaging may be monitored, for example: •AOL Instant Messenger •Yahoo Messenger •Microsoft Messenger •ICQ

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic drawing of the architecture of the software of the present invention as it may be used on a computer system in a business enterprise.

FIG. 2 is a diagrammatic drawing of one application of the software of the present invention.

FIG. 3 is a diagrammatic drawing of a second application of the software of the present invention.

FIG. 4 is a diagrammatic drawing of the computer system of the present invention.

FIG. 5 is schematic diagram of a second embodiment of the present invention.

FIGS. 6 and 7 are schematic diagrams of client server architectures of the present invention.

FIG. 8 is a block diagram of a file stored according to one embodiment of the present invention.

FIGS. 9-11 are block diagrams of file and archive alterations and interactions with the present invention.

FIGS. 12A and B are a flow chart diagram of the operation of the present invetnion.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation. Data structures contain both “instance” and “meta data” components, with the “data instance” component being the value of the data (for example, the numeric value of 5 or the textual value of “five”) and the “data meta data” component being the format and definitional aspects of the data (for example, the meta data of 5 may be the record number in a numeric format and the meta data of “five” may also be the record number but in a textual format). The data meta data component is capable of inheriting the value of another data meta data component. For example, if a first table has a numeric value of 5 (data instance component) in record number 5 (meta data), a second table's record number 6 (meta data) may inherit the numeric value of 5 (data instance) from the first table as determined by rules used to manage the tables These structures and data can be reflected in systems such as databases, files, or communication streams.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct a more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “business events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output. JAVA is one object-oriented programming language that, when complied, can run on most computers (JAVA is a registered trademark of Sun Microsystems, Inc. of Palto Alto, Calif., 94303).

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. A “virtual” server is a server that shares computer resources with other servers. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “wireless wide area network”, “WWAN”, “wireless local area network” or “WLAN” are used in reference to a wireless network (LAN or WAN) that uses high frequency radio waves rather than wires to facilitate the transmission of data between computing devices.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term API includes A language and message format used by an application program to communicate with the operating system or some other control program such as a database management system (DBMS) or communications protocol. APIs are implemented by writing function calls in the program, which provide the linkage to the required subroutine for execution. Thus, an API implies that some program module is available in the computer to perform the operation or that it must be linked into the existing program to perform the tasks. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats in conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. XML is an open standard for describing data from the W3C. It is used for defining data elements on a Web page and business-to-business documents. The XML file may be analogized to an object, as the data and the stylesheet formatting are separately contained (formatting may be thought of as methods of displaying information, thus an XML file has data and an associated method).

Further terms are used with the following definitions. “Archive” refers to a repository, usually residing on an Archive Server, that contains compressed and encrypted data received from clients. “Archive File” refers to a file that has been backed up from a client to a server and compressed and encrypted. “Archive Server” refers to a server used to store data from a ZOMA DataVault client(s) as compressed and encrypted. “Block” refers to a section of a file that contains the data for that section. Blocks may be fixed sizes or various sizes, possibly utilizing variable block sizes for performance and optimization. “Client” refers to a computer (PC, laptop, etc.) containing data sources to be monitored for changes in state. When a change of state is detected, the incremental changes are sent to the Archive Server. “Complex Event Processing (CEP)” refers to a defined set of tools and techniques for analyzing and controlling the complex series of interrelated events that drive modern distributed information systems. “Comprehensive Scan” refers to a complete scan process on the client of all directories and files being monitored. Typically used for the “seed” round or on an ad hoc basis.

“Encryption” refers to the reversible transformation of data from the original (the plaintext) to a difficult-to-interpret format (the ciphertext) as a mechanism for protecting its confidentiality, integrity and sometimes its authenticity. Encryption uses an encryption algorithm and one or more encryption keys. “File Archive” refers to a repository that resides on the ZOMA DataVault Archive Server. All changes to monitored directories and files are archived to this repository. “File Header” refers to a part of an Archive File that maintains attributes of the file. There is one File Header for each Archive File. “Hash Code” refers to a unique identifier generated as a summary of data in a file in its uncompressed and unencrypted form.

“Hash Table” refers to a compilation of Hash Codes for each of the blocks of data in a file. It is primarily used to determine what changes have occurred since the last archived version. The Hash Table is built for new files and then maintained as updates occur. The Hash Table is stored at the end of the Archive File on the Archive Server. Each time an update occurs to the file, the Hash Table is loaded into the Archive Server's memory. It is updated by the changed blocks and then stored at the end of the file again. This allows for indexes to be self contained in the file. There is one Hash Table for each Archive File.

“Index” refers to an index of files contains an entry for each file name and the location of the file. “Java 2 Platform, Enterprise Edition (J2EE)” refers to a platform from Sun Microsystems for building distributed enterprise applications. J2EE services are performed in the middle tier between the user's machine and the enterprise's databases and legacy information systems. J2EE comprises a specification, reference implementation and set of testing suites. More generally, a reference to J2EE indicates an open source architecture platform for the implementation of enterprise computing systems. “Lightweight Directory Access Protocol (LDAP)” refers to a protocol used to access a directory listing. “Meta Data Archive” refers to a repository that resides on the ZOMA DataVault Archive Server. Changes to monitored data sources have the meta data with the associated data sources archived to this repository. “Network Attached Storage (NAS)” refers to a specialized file server that connects to the network. A NAS device contains a slimmed-down (microkernel) operating system and file system and processes only I/O requests by supporting popular file sharing protocols. “Post Office Protocol 3 (SMTP)” refers to a standard mail server commonly used on the Internet. It provides a message store that holds incoming e-mail until users log on and download it. POP3 is a simple system with little selectivity. All pending messages and attachments are downloaded at the same time. POP3 uses the SMTP messaging protocol.

“Quick Scan” refers to polls at a specified interval and compares the modify data/time of the file and/or directory being monitored on the client with the last scan date/time stored in a file on the client to determine if the file and/or directory has been changed since the last poll. “Seed” refers to, after the Archive Server is installed and configured, the first complete cycle of the Archive process writes all data being monitored from the client to the Archive Server. This phase is referred to as the “seed” cycle.

“Simple Mail Transfer Protocol (SMTP)” refers to the standard e-mail protocol on the Internet. It is a TCP/IP protocol that defines the message format and the message transfer agent (MTA), which stores and forwards the mail. SMTP servers route SMTP messages throughout the Internet to a mail server, such as POP3 or IMAP4, which provides a message store for incoming mail. “Storage Area Network (SAN)” refers to a network of storage disks. “SYSLOGD” refers to a collection mechanism for various logging messages generated by the kernel and applications running on UNIX operating systems. “Tamper” refers to an unauthorized change to a data source. “Transactional Archive” refers to a repository that resides on the Archive Server. All monitored changes to databases, email, IM's, etc. are archived to this repository. “Transmission Control Protocol/Internet Protocol (TCP/IP)” refers to a communications protocol. TCP/IP is a routable protocol, and the IP part of TCP/IP provides this capability. In a routable protocol, all messages contain not only the address of the destination station, but the address of a destination network. This allows TCP/IP messages to be sent to multiple networks (subnets) within an organization or around the world, hence its use in the worldwide Internet. “Version” refers to a set of file changes written from the client to the Archive Server in one interval of the Archive Server. “Version Header” refers to a portion of a Version which contains the version attributes, version number (that is incremented with each subsequent change), File Deleted Flag, and Tamper Detection Flag.

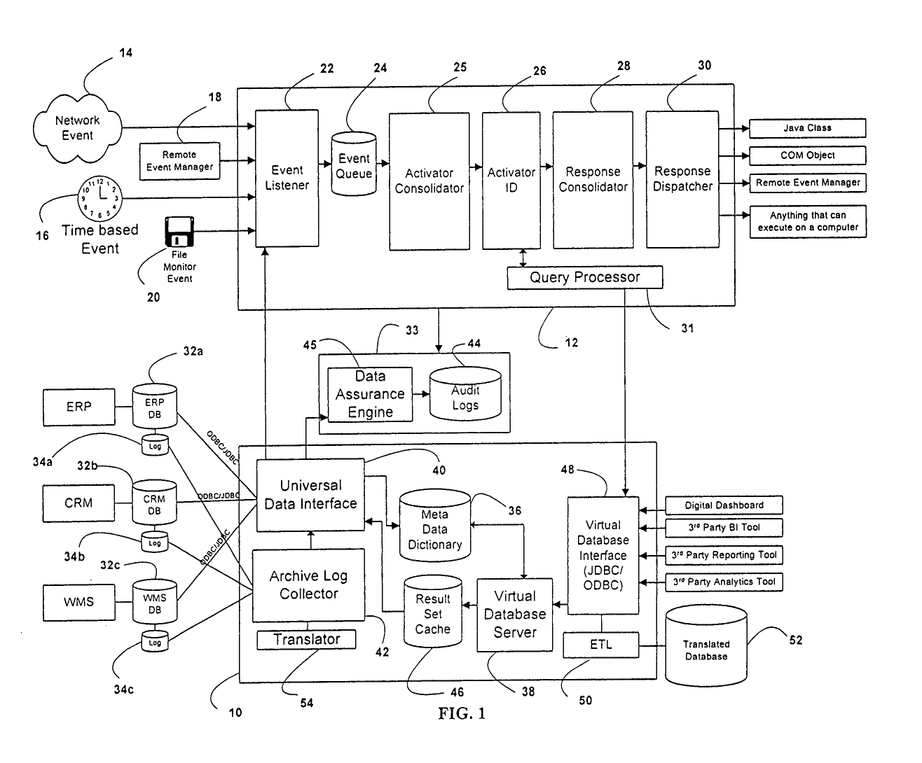

The present invention involves software embodying a method of reducing information latency in a computer system used in a business enterprise. A business enterprise is hereinafter defined as any entity engaged in the activity of providing goods and/or services involving any of financial, commercial, and industrial aspects. The architecture of the software is shown in FIG. 1. The software includes three modules: data manager 10, event manager 12, and data assure 33. Data manager 10 manages, identifies, and provides access to real-time business information. Event manager 12 detects, identifies, and responds to changes in a business environment in real-time. Data assure 33 provides full data instance and data meta data accountability throughout an enterprise.

Data manager 10 manages the interface between the software of the present invention and data sources 32a, 32b, 32c. Data manager 10 provides a federation infrastructure for all enterprise systems, and its primary functions include extracting data meta data and loading meta data dictionary 36, monitoring transaction files or monitoring network streams for transactions 34a, 34b, 34c for changes made to data instances and data meta data, and maintaining result set cache 46 and meta data dictionary 36. Data manager 10 is comprised of archive log collector 42, universal data interface 40, result set cache 46, meta data dictionary 36, virtual database interface 48 and virtual database server 38.

Data manager 10 serves as a monitor of data collection points. Several types of data collection points may be monitored, an such collection points may be referred to as “Collectors.” Different types of Collectors may be categorized that may be used for each type of data collection point. The following defines each Collector category: (A) Local Collector—Collects data only on the computer on which the Collector is installed; (B) Remote Collector—These Collectors are installed on computers in central locations that can remotely monitor multiple systems at the same time. There are two types of Remote Collectors: Passive and Active. A Passive Remote Collector watches the data stream without intercepting it. An Active Remote Collector registers itself with the associated protocol as a recipient of the data; (C) Passive Network Monitor Collector—This type of Remote Collector passively monitors network packets, decodes them into their associated protocols, and stores the relevant data and meta data; (D) Operating System Monitor Collector—This type of Local Collector monitors operating system calls and events in the core of the operating system to determine changes in state.

For example, Application Logs may have a Local Collector, a Remote Collector, or Passive Network Monitor Collector. Database Logs may have a Local Collector. Database Schemas may have a Local Collector or Passive Network Monitor Collector. Database Transactions may have a Local Collector or Passive Network Monitor Collector. Device Logs may have any of Local Collector, Remote Collector, Passive Network Monitor Collector. Enterprise Email Applications may have a Local Collector, Remote Collector, or Passive Network Monitor Collector. Enterprise Instant Message Applications may have Local Collector, Passive Network Monitor Collector. Files may have a Local Collector; a Remote Collector, or a Passive Network Monitor Collector. FTP (File Transfer Protocol) may have a Traffic Passive Network Monitor Collector. HTTP (HyperText Transport Protocol) Traffic may have a Local Collector, Remote Collector, or Passive Network Monitor Collector. LDAP (Lightweight Directory Access Protocol) Traffic may have Local Collector or Passive Network Monitor Collector. Message Queues Local Collector may have a Remote Collector or Passive Network Monitor Collector. Network Traffic may have a Local Collector or Passive Network Monitor Collector. Operating Systems may have a Local Collector. RSS (Rich Site Summary) Feeds may have a Remote Collector. SCP (Secure Copy Protocol) Traffic may have Passive Network Monitor Collector. SOAP (Simple Object Access Protocol) Messages may have Remote Collector or Passive Network Monitor Collector. SNMP (Simple Network Management Protocol) Messages may have Remote Collector or Passive Network Monitor Collector. System Logs may have Local Collector, Remote Collector, or Passive Network Monitor Collector. Web-Based Email Applications may have Local Collector or Passive Network Monitor Collector. Web-Based Instant Message Applications may have a Local Collector or Passive Network Monitor Collector. Thus, various sources of data and messaging may be monitored at these various collection points. The foregoing listing is exemplary in nature and other comibinations and configurations may be compatible with the present invention.

The use of collectors to monitor dynamic data flows, as opposed to static data storage, may be illustrated by the following outline of how a Collector may monitor and detect Instant Messages across a network. First, a Collector monitors designated network for packets of data. When packets containing Instant Messages are identified by TCP/IP port/service numbers used for Instant Message protocols (Yahoo, MSN, AOL, ICQ, etc.), the identified packets are decoded into the data and meta data associated with the Instant Message packet sent. For example, a Yahoo Instant Message would have the following meta data: ‘from user’, ‘to user’, ‘date and time’, ‘message type’ (text, voice, video), and ‘message data’ along with the associated data sent. Once decoded, the messages are sent to a centralized Collector via an ASN.1 protocol. The Collector sends the data and meta data to a centralized repository to be stored. Finally, any Events set up to use this type of data transaction, would be initiated and processed. In addition to using Collectors for monitoring such instant text messaging, similar procedures may be used to monitor standard electronic mail (e-mail) messages or voice over internet protocol (VoIP) messages.

Archive log collector 42 polls transaction files or monitors network streams for transactions 34a, 34b, 34c at predetermined intervals. When archive log collector 424 detects a change in any of data sources 34a, 34b, 34c, it reads the transaction from the file o rnetwork stream, decodes the SQL (if necessary), and sends the result to universal data interface 40. “SQL” or “Structured Query Language” is a standard query language for requesting information from a database.

When universal data interface 40 receives results from archive log collector 42, it clears result cache 46 and then sends the data instance/data meta data changes to meta data dictionary 36. When data sources 32a, 32b, 32c are initially set up, universal data interface 40 automatically reverse-engineers the data models of data sources 32a, 32b, 32c and extracts the data meta data to populate meta data dictionary 36. If event manager 12 is used and an event has been defined for the detected data instance/data meta data changed, universal data interface 40 initiates the associated event in event manager 12. If data assure 33 is used, universal data interface 40 notifies data assurance engine 45 of the data instance/data meta data change and sends the changed data instance/data meta data to meta data dictionary 36.

Result set cache 46 stores the results of queries performed by virtual database server 38 and is used to reduce the need to re-query information from data sources 32a, 32b, 32c when the data instance has not been changed. When result set cache 46 receives query requests from virtual database server 38, if it does not contain the requested information, then it sends a request to universal data interface 40 in order to obtain the data instance from data sources 32a, 32b, 32c. Universal data interface 40 returns the results to result set cache 46, which stores the results and then sends the results to virtual database server 38.

Meta data dictionary 36 is initially created when universal data interface 40 extracts data meta data from data sources 32a, 32b, 32c. Once created, universal data interface 40 sends data and data meta data changes to meta data dictionary 36 to be updated. Time stamps for the data and data meta data changes are recorded to allow the detection of any changes in transaction files 34a, 34b, 34c from a specific time and date.

Virtual database interface 48 is accessed by 3^{rd} party applications, e.g., digital dashboard, reporting tools, analytics tools, etc., to extract data instances from result set cache 46 via virtual database server 38 or data sources 32a, 32b, 32c via universal data interface 40.

Virtual database server 38 federates all of enterprise data sources 32a, 32b, 32c into one logical server. Request can be made to multiple database servers throughout the organization through virtual database 38. Virtual database interface 48 sends query requests received via query processor 31 to virtual database server 38, upon which time virtual database server 38 goes to meta data dictionary 36 to determine the location of the requested data instance for the query. Once meta data dictionary 36 returns the requested data instance location to virtual database server 38, it looks for the requested data instance in result set cache 46. If the requested data is in result set cache 46, virtual database server 38 returns the results to virtual database interface 48 for continued processing. If the requested data instance is not found in result set cache 46, result set cache sends a request to universal data interface 40 in order for the data instance to be retrieved from data sources 32a, 32b, 32c. The results are returned to virtual database server 38 and is then sent to virtual database interface 48 for continued processing.

The software also includes event manager 12. Again referring to FIG. 1, event manager 12 is comprised of activator actions, event listener 22, event queue 24, activator consolidator 25, activator identification 26, query processor 31, response consolidator 28, response dispatcher 30, response actions and audit logs database 44.

An activator action polls for or receives an initiating event. It then notifies event listener 22 of the action and sends the associated data. Event listener 22 monitors and detects changes in enterprise systems for discrete changes. An event listener is an object that contains listener methods that are specialized to different types of Business Events. Event listener 22 is necessary for the software of the present invention to respond to an event. Event listener 22 awaits messages from universal data interface 40, archive log collector 42, network events 14 triggered by network devices, time-based events 16 triggered by an internal clock, information sent through a network, changes in files, changes in directories, or messages from other events or actions 18. Event listener 22 is passive until it receives a message, at which time it pushes appropriate messages onto event queue 24.

Event queue 24 stores activator and response actions to be processed. The data necessary to execute the action is also stored. For activator actions, activator consolidator 25 pulls the actions and associated data from event queue 24. For response actions, response consolidator 28 pulls the actions and associated data from event queue 24.

Activator consolidator 25 pulls the next message from event queue 24 and initiates activator identification 26. If consolidation has been activated, activator consolidator 25 summarizes all similar messages for a particular activation action into one message and removes those messages from event queue 24.

Activator identification 26 receives activator actions from activator consolidator 25 and then evaluates a logical expression to determine if the activator action should result in a response action. The logical expression is predetermined business logic to an action to evaluate the significance of a data instance or meta data change. Business logic includes all of the evaluations, decisions, transitions, transformations, requests and responses necessary for the business enterprise to carry out its business functions. The business logic is defined by the user of the system in which the present invention is used, and the user determines the significance of any data instance and/or data meta data changes. If the identification is true, the activator identification pushes a message to event queue 24 to execute a response. In some cases, activator identification 26 is not able to determine if a response action should be initiated until a query is performed. In such a case, activator identification 26 sends a request to query processor 31. When the results are received from query processor 31, activator identification 26 evaluates the results to determine if the activator action should result in a response action. If the identification is true, activator identification 26 pushes a message to event queue 24 to execute a response.

Query processor 31 receives requests for data instances from activator identification 26. Query processor 31 sends the requests to virtual database interface 48. When the results are received from virtual database interface 48, query processor 31 sends the information to activator identification 26.

Response consolidator 28 functions similar to activator consolidator 25. Response consolidator 28 pulls the next message from event queue 24 and moves the response action to response dispatcher 30. If consolidation has been activated, response consolidator 28 summarizes all similar messages for a particular response action into one message and removes those messages from event queue 24. Response consolidator 28 uses time and volume as timing parameters in determining when to push response actions to response dispatcher 30 (e.g., push every hour, or push every 1000 events, or push every 1000 events/hour).

Response dispatcher 30 receives response actions from response consolidator 28 and then initiates the response actions. The function or code associated with the response action is executed in response to an action activator. Response dispatcher 30 supports distributed processing so that actions can be dispatched on multiple systems. Response dispatcher 30 is capable of executing most programs that can be executed on a computer, and it can execute either local or remote responses.

Event manager 12 logs all event activity in audit log 44. Event manager 12 also is capable of generating time-based events based on the entries in the event table and those in event queue 24.

Data assure module 33 validates the integrity of transaction files 34a, 34b, 34c when data sources 32a, 32b, 32c are modified, even if the modifications are outside of an application. Data assure 33 performs a security hash algorithm on incoming data to detect data tampering, and it also writes an audit trail, executed SQL, and the changed data in audit logs database 44. Data assure 33 includes data assurance engine 45 and audit logs database 44.

After universal data interface 40 sends a message to data assurance engine 45 that a data instance and/or data meta data has changed, data assurance engine 45 performs a security hash algorithm (described in detail infra) on the changed data instance and/or data meta data. Data assurance engine 45 then writes an audit trail, the executed SQL, and the changed data instance and/or data meta data to audit logs database 44.

Shown in FIG. 1, the software implemented method of the present invention may be used in a business enterprise having a computer system which includes one or more data sources 32a, 32b, 32c. Data sources may include, but are not limited to, databases, as shown in FIG. 1, files, application programs, and web servers. Data sources 32a, 32b, 32c each contain a plurality of data instances. For example, data source 32a may store a plurality of data instances related to financial data, data source 32b may store data instances related to customer data and data source 32c may contain data instances related to product shipment data. Data sources 32a, 32b, 32c are associated with transaction files 34a, 34b, 34c. Transaction files 34a, 34b, 34c are log files that record and store all transactions occurring in data sources 32a, 32b, 32c, including any changes made to data instances and data meta data. Log files generated by databases are generally not text files and must be processed for interpretation. Log files generated by application programs and web servers are generally text files and normally may be interpreted without processing.

Data manager 10 uses common JAVA tools to extract data meta data from data sources 32a, 32b, 32c. Data manager 10 then uses the extracted meta data to build data dictionary 36 by storing the meta data in a unique format in meta data dictionary 36. Data meta data defines the organization of data sources 32a, 32b, 32c. For example, if data source 32a is a database, the data meta data may define the tables in the database, the fields in each table, and the relationships between the fields and tables. When initially created, meta data dictionary 36 stores the current state of data instances in data sources 32a, 32b, 32c and the meta data related to those data sources.

Virtual database server 38 is in communication with and provides access to plurality of data sources 32a, 32b, 32c. Virtual database server 38 may be a dedicated or a virtual server. Queries submitted by a user through virtual database server 38 may span any of data sources 32a, 32b, 32c.

In one form of the present invention as described above, data sources 32a, 32b, 32c provide information regarding changes made to their data instances and meta data in the form of data transaction files 34a, 34b, 34c.

In another form of the present invention, data sources 32a, 32b, 32c provide transaction information in the form of action messages. An action message is a textual or numerically coded message that describes an action performed on the data instance and/or meta data. In this form of the present invention, data sources 32a, 32b, 32c and meta data dictionary 36 (or application servers associated with data sources 32a, 32b, 32c and meta data dictionary 36) temporarily store each action made within data sources 32a, 32b, 32c. When an action occurs, the appropriate application server creates a message noting the action and sends this action message to virtual database server 38. Upon receipt of the action message, virtual database server 38 analyzes the action message to determine whether either a data instance or data meta data has been changed. If the action message indicates a change and an activator action has been defined for the changed data instance or meta data, then a message with the changed data is pushed from universal data interface 40 to event queue 24 via event listener 22. The action message is also stored in audit log 44.

In still another form of the present invention, data sources 32a, 32b, 32c utilize database triggers to indicate changes made to data instances or data meta data. A database trigger is a program module that is executed when predefined changes are made to data instances or data meta data. Accordingly, with the use of database triggers, any predefined change to data instances and/or meta data in data sources 32a, 32b, 32c causes data manager 10 to send a message to event listener 22 via universal data interface 40.

It is now useful to describe the method of the present invention. The first step of the method of the present invention includes accessing data sources 32a, 32b, 32c and obtaining transaction information relating to any changes in data sources 32a, 32b, 32c. As described above, data sources 32a, 32b, 32c generate transaction files 34a, 34b, 34c. Because transaction files 34a, 34b, 34c provide a detailed record of every transaction that has taken place in data sources 32a, 32b, 32c, including changes made to data instances and meta data, files 34a, 34b, 34c provide sources of information that archive log collector 42 accesses in determining whether a change has occurred in data instances and meta data. Transaction files 34a, 34b, 34c not only indicate whether either data instances or meta data have changed, but in many cases, transaction files 34a, 34b, 34c also indicate to and from what the instance or meta data have changed. For example, if data source 32a had a data instance of “2” in row A, and that data instance was changed to “3”, database transaction file 34a would indicate as much.

Archive log collector 42 accesses and obtains transaction information from data sources 32a, 32b, 32c by periodically monitoring files 34a, 34b, 34c to check for content indicating that a change has been made to a data instance or data meta data. Archive log collector 42 checks for changes in files 34a, 34b, 34c at a static interval (e.g., once every 1-5 seconds) determined by both the user and the scalability of the system in which the present invention is used. If transaction files 34a, 34b, 34c are non-text files, archive log collector 42 utilizes translator 54 to process and interpret files 34a, 34b, 34c. If files 34a, 34b, 34c are text files, translator 54 may not be necessary.

As described above, when created, meta data dictionary 36 represents the current state of the data instances and data meta data in data sources 32a, 32b, 32c. When a data instance change occurs and is committed to any of data sources 32a, 32b, 32c, data dictionary 36 is updated for appropriately changed columns, tables, and meta data. If a column changes, data manager 10 automatically refreshes the date and time stamp in the table and meta data definitions. In one form of the present invention, if an activator action has been defined for the data instance that has changed, archive log collector 42 sends a message with the changed data instance to event listener 22 to initiate an event.

In another form of the present invention, a user of the system in which the present invention is implemented may scan meta data dictionary 36 to determine if a data instance change has occurred. If an Extraction, Transformation, and Load (“ETL”) has been defined for the changed data instance, data manager 10 will push the data instance to a local transformation queue and execute compiled JAVA ETL code to push the data to appropriate data source 32a, 32b, 32c in near real-time. An ETL transforms data meta data from one form to another (e.g., transforming the way data is stored in one database to the way the same data is stored in another database). The changed data instance is stored in audit log 44 for any future auditing that may be necessary. The user who made the data instance change, the data instance change, and a time and date for the change may be stored as well. A message is then pushed to virtual database server 38 to expire any cache entries in result set cache 46 that utilized any elements that were modified by the query that changed the data instance.

When a data meta data change occurs, including security changes, meta data dictionary 36 is updated. Update dates for table and meta data definitions are updated as well. If an activator action has been defined for the changed data meta data, archive log collector 42 sends a message with the changed meta data to event listener 22 to initiate an event. If an ETL has been defined for the changed meta data and the change results in the ETL no longer being able to be executed, the compiled JAVA ETL code is disabled and any future meta data changes stay in the local transformation queue and are not pushed to appropriate data source 32a, 32b, 32c. Archive log collector 42 then sends a message to event listener 22. The meta data change is then stored in audit log 44.

Any time that a change is made to a data instance and/or data meta data, the change is documented in files 34a, 34b, 34c. Upon monitoring transaction files 34a, 34b, 34c, archive log collector 42 ascertains whether any such changes have been made. After ascertaining whether any changes have occurred in data instances and/or data meta data, the software-implemented method of the present invention proceeds to a step of determining, based on the changed data instances and/or data meta data, if a response to an initiated event is necessary.

As described above, if a data instance or data meta data change defines an activator action, archive log collector 42 sends a message to event listener 22. Event listener 22 is passive until it receives a message. Upon receipt of a message from archive log collector 42, event listener 22 pushes the message onto event queue 24. Action consolidator 25 then pulls the message from queue 24 and initiates activator identification 26, which then applies predetermined business logic to the message in order to determine the relevancy of the data instance or data meta data change. Relevancy is determined by the use of the system in which the method of the present invention is implemented. The user may determine that particular messages are insignificant and do not require a response. Other messages may be critical and require an immediate response. Response consolidator 28 collects and analyzes the relevant messages from event queue 24 and pushes response actions to response dispatcher 30. Finally, response dispatcher 30 initiates the response actions and dispatches the initiated events. As will be described by example, all dispatched events are associated with conditions that enable the computer system to respond to the events.

In some situations, the dispatched event may want to execute a query against data source 32a, 32b, 32c based on a changed data instance and/or data meta data. In being a universal interface between events and data sources 32a, 32b, 32c, universal data interface 40 handles all such queries. In querying data sources 32a, 32b, 32c, virtual database server 38 is utilized. Virtual database server 38 maintains virtual data meta data, i.e., a virtual representation of the data meta data in meta data dictionary 36 of data sources 32a, 32b, 32c. The primary utility of virtual data meta data is that data sources 32a, 32b, 32c do not need to be replicated to one data source. Virtual database interface 48 provides, in one embodiment, JAVA database connectivity and open database connectivity access to the virtual data meta data. The virtual data meta data takes a query presented to virtual database server 38 and breaks the query up into independent queries for each of data sources 32a, 32b, 32c. The individual queries check result set cache 46 to see if there is a cached entry that can be utilized to return the needed result set. If a cached entry is not found, the query is sent to actual data source 32a, 32b, 32c via universal data interface 40 and the returned result set is stored in cache 46. Result set cache 46 may be automatically purged by data manager 10 if one of the data instances and/or data meta data in the cached entry has changed.

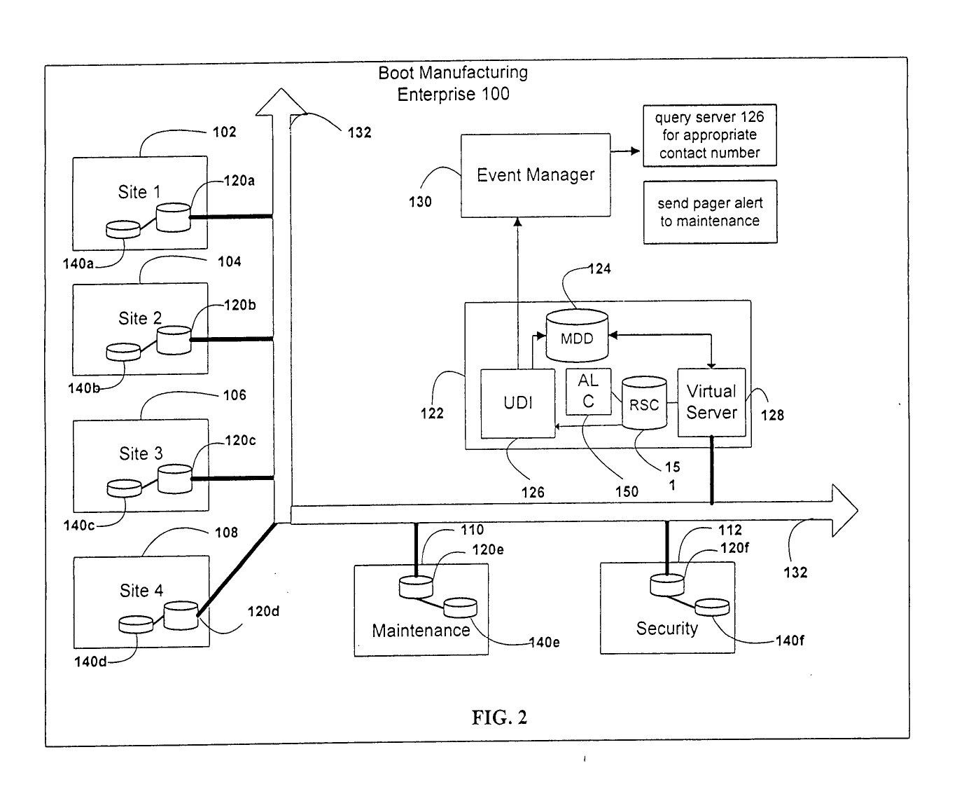

The following examples are beneficial to understanding the present invention. Referring to FIG. 2, the software-implemented method of the present invention may be used in business enterprise 100, a Boot Manufacturing Enterprise. Boot Manufacturing Enterprise 100 includes multiple sites 102, 104, 106, 108, maintenance facility 110 and security facility 112. Each of sites 102, 104, 106, 108, maintenance facility 110 and security facility 112 include data sources 120a, 120b, 120c, 120d, 120e, 120f. Data sources 120a, 120b, 120c, 120d, 120e, 120f store different types of data. Data sources 120a, 120b, 120c store site data, data source 120e stores maintenance data, and data source 120f stores security data.

Regarding the use of the software of the present invention within Boot Manufacturing Enterprise 100, universal data interface 126 extracts data meta data from data sources 120a, 120b, 120c, 120d, 120e, 120f and builds meta data dictionary 124. Universal data interface 126 provides access to all of data sources 120a, 120b, 120c, 120d, 120e, 120f over network 132. Network 132 may be any of a LAN, WAN, WLAN, WWAN or the Internet.

If site 108 experiences a power failure at 2:00 p.m., a write operation will be performed on a data instance (e.g., power usage data) stored in data source 120d. Meta data dictionary 124 is updated for appropriately changed columns, tables, and data meta data, and if a column changes, data manager 122 automatically refreshes the date and time stamp in the table and meta data definitions. If the user of the system defines an activator action for a change in a power usage data instance, archive log collector 150 sends a message to event manager 130.

Log file 140d generated by data source 120d indicates that a change has occurred in the data instance stored in data source 120d. Archive log collector 150 monitors log files 140a, 140b, 140c, 140d, 140e, 140f, and upon detecting in 140d that a data instance has changed in data source 120d and determining that an activator action has been defined for the data instance change, universal data interface 126 sends a message to event manager 130. Upon receipt of the message, event manager 130 queues the message and uses predetermined business logic to determine whether the message is relevant. If the message is relevant, event manager 130 dispatches the event. The event may need to query data sources 120a, 120b, 120c, 120d, 120e, 120f to determine whether the power failure is either a site failure or an enterprise failure. In doing so, the event submits a query to virtual server 128. Virtual server 128 breaks the query into independent queries for each of data sources 120a, 120b, 120c, 120d, 120e, 120f.

The event triggered by a change in the power usage data instance is associated with a condition that determines as to how the event is responded. The condition may be as simple as the following if-then condition statement: If a change in a power usage data instance indicates a power failure between the times of 9:00 a.m. and 9:00 p.m., then send a pager alert to someone in maintenance facility 110. In responding to this event, a user of the software of the present invention may need to query data source 120e via virtual server 128 and universal data interface 126 to find out which maintenance worker is on call during the power failure. After determining the appropriate worker to page, the software responds to the event by paging the maintenance worker in maintenance facility 110.

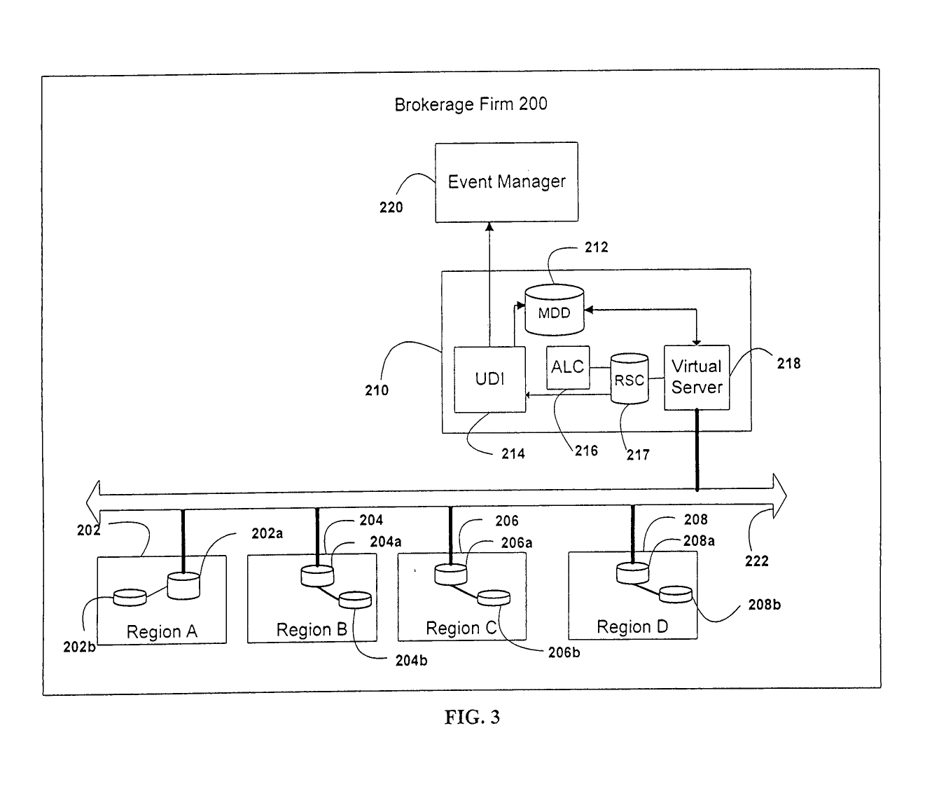

The software-implemented method of the present invention may also be used in a business enterprise such as Brokerage Firm 200 shown in FIG. 3. Brokerage Firm 200 may desire to use the software to determine in real-time when a customer transfers a large portion of its balance out of its account in order to ensure that the transfer is authorized. Brokerage Firm 200 may also wish to determine why the customer is possibly leaving the firm.

Brokerage Firm 200 serves clients in multiples regions 202, 204, 206, 208. Each of regions 202, 204, 206, 208 include data sources 202a, 204a, 206a, 208a. Data sources 202a, 204a, 206a, 208a store regional customer account data. Universal data interface 214 extracts data meta data from data sources 202a, 204a, 206a, 208a and builds meta data dictionary 212.

If a client in region 202 withdraws over 50% of their balance from their account, for example, a data instance relevant to account balance percentage and stored in data source 202a is changed. Meta data dictionary 212 is updated for appropriately changed columns, tables, and data meta data, and if a column changes, data manager 210 automatically refreshes the date and time stamp in the table and data meta data definitions.

Log file 202b generated by data source 202a indicates that a change has occurred in a data instance stored in data source 202a. Archive log collector 216 monitors log files and/or communication streams to and from an application and an information source 202b, 204b, 206b, 208b and detects in log file or communication stream 202b that a data instance relevant to account balance percentage has changed in data source 202a. The data instance indicates that 53% of the customer's balance has been transferred from a customer account. Because the system administrator of Brokerage Firm 200 has defined an activator action for any change in this data instance, archive log collector 216 sends a message to event manager 220. Upon receipt of the message, event manager 220 queues the message and uses predetermined business logic to determine whether the message is relevant (e.g., is Brokerage Firm 200 still using an 50% account transfer amount as the flagging mark?). If the message is relevant, event manager 220 dispatches an event.

The event triggered by the change in the data instance is associated with a condition that determines as to how the event is responded. In this example, the condition may be described by the following statement: If a customer transfers more than 50% of their account balance, then insert a call request into the call center queue and update the CRM system. The software responds accordingly.

The software of the present invention also detects data tampering in data sources 32a, 32b, 32c (FIG. 1) with a record level security hash performed by data assurance engine 45. A hash (or “hash code”) is a number generated from a string of characters or other data. The hash is typically a fixed length value that is smaller than the original string of characters or data but represents the original string. The hash is generated so that it is highly unlikely that another string of characters or other data will produce the same hash. Hashes such as the one used in the method of the present invention are used to ensure that unauthorized action is not performed on the pertinent data. In the software-implemented method of the present invention, a record level security hash is used to protect the integrity of the data instances in data sources 32a, 32b, 32c.

While many known hash functions may be used in accordance with the method of the present invention, the following description of a hashing function illustrates one use of a simplified hash function to detect data tampering in data sources 32a, 32b, 32c. Again referring to FIG. 1, when an authorized application either inserts or modifies a row in any of data sources 32a, 32b, 32c, the application requests a security hash code from the software based on the contents of that row. A hashing function transforms the data string in the row into a shorter fixed-length value (i.e., the security hash code) that represents the original data string. The hashing function utilizes a cyclical redundancy code to combine the elements of the data plus an encryption key stored in the application. The hash code is sufficiently unique that in most instances, changing a data element in the row will change the value of the hash code. The hash code is stored in either the row associated with that table or a supplemental table, and the user who inserted the row is logged in audit log 44.

When a row in any of data sources 32a, 32b, 32c is modified by an unauthorized application, the transaction is captured in transaction files or communication streams 34a, 34b, 34c. By monitoring transaction files 34a, 34b, 34c, archive log collector 42 ascertains that a row in a table of one of data sources 32a, 32b, 32c has been modified, or universal data interface 40 may notify data assurance engine 45 of the data ins/data meta data change. The software generates a test hash code based on the modified data contents of the row. If the test hash code does not equal the row's stored security hash code, then it is determined that the row was modified by an unauthorized application. The hash code mismatch is then logged in audit log 44 along with information associated with the user of the unauthorized application. An activator action is then sent to event manager 12 for additional actions to be performed as necessary.

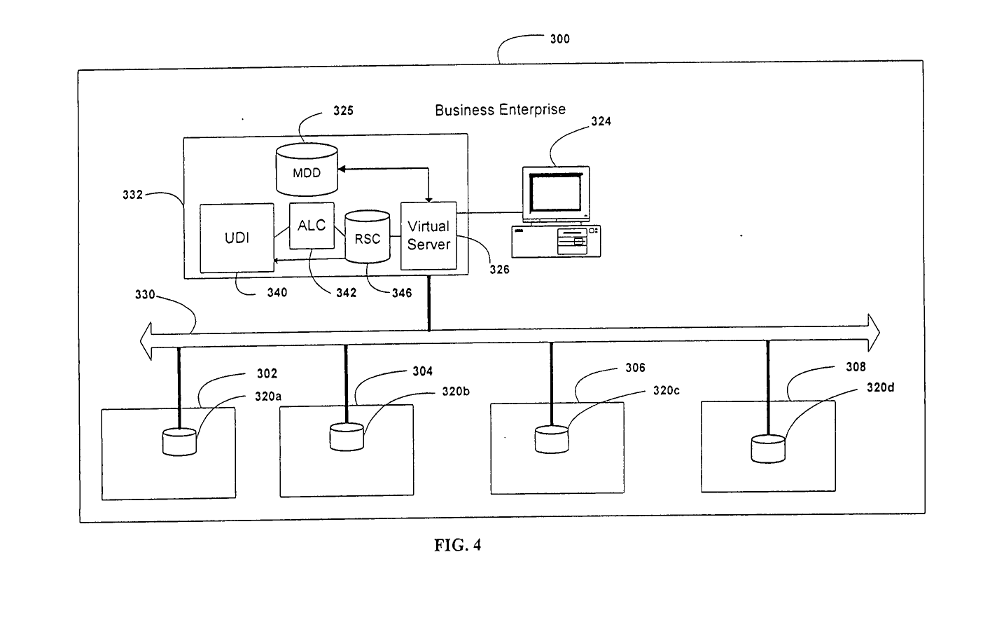

The present invention also provides a computer system for use in a business enterprise on which the software of the present invention may be used. Shown in FIG. 4, the computer system suitable for use with the present invention includes communications network 330 (e.g., a LAN, WAN, WLAN, WWAN or the Internet) and virtual server 326 (a computer with storage and communications equipment suitable for communicating over network 330) coupled to communications network 3230. Virtual server 326 is in communication with a plurality of enterprise data sources 320a, 320b, 320c, 320d that store data. Virtual server 326 may provide real-time access to this data.

Computer 324 is coupled to virtual server 326 and includes a query system (not shown) for enabling a user of computer 324 or an initiated event to query virtual server 326 relating to the data stored in any of enterprise data sources 320a, 320b, 320c, 320d. When virtual server 326 initiates a query to enterprise data sources 320a, 320b, 320c, 320d, it stores a copy of the results in result set cache 346. Result set cache 346 allows virtual database server 326 to return to the results without having to query enterprise data sources 320a, 320b, 320c, 320d. Any time a data instance change is detected in one of enterprise data sources 320a, 320b, 320c, 320d, result set cache 346 is purged of any result sets that contained data instances that might have changed. Result set cache 346 may then be manually or automatically updated with the new query results through events in event manager 332 or through virtual database server 326.

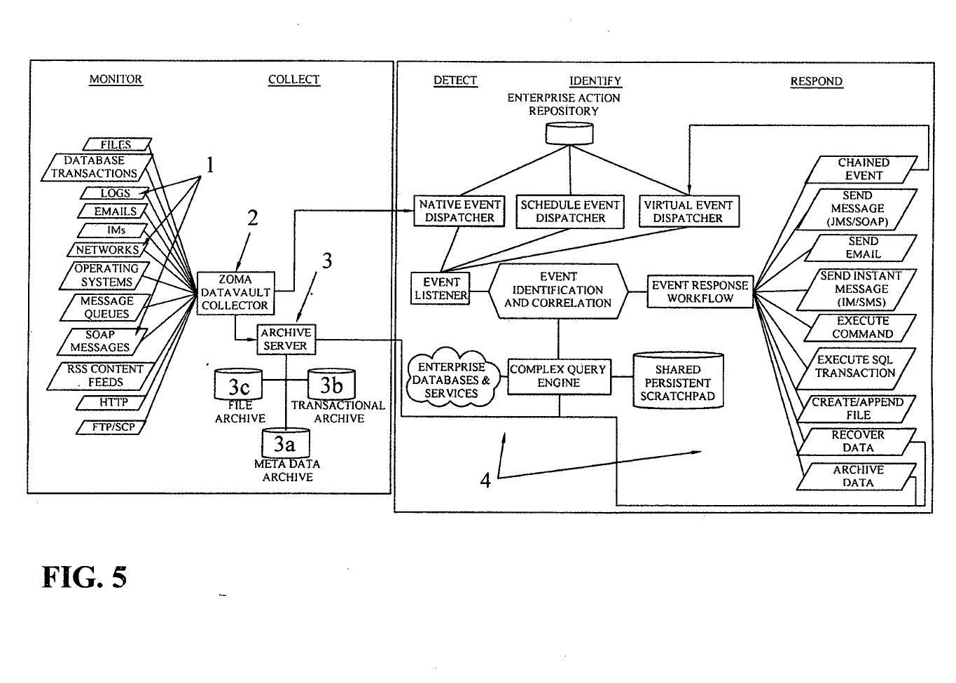

An additional embodiment of the invention is depicted in FIG. 5. ZOMA DataVault Architecture components include the following: 1. ZOMA DataVault Monitors—Monitors data sources for changes in state. Monitored data is sent to the ZOMA DataVault Collector when a change in state is detected. 2. ZOMA DataVault Collector—Collects data and meta data changes from the ZOMA DataVault Monitors. Collected changes are sent to the Archive Server. 3. Archive Server—All changes detected by ZOMA DataVault are sent to the Archive Server. The Archive Server is comprised of three repositories: a. Meta Data Archive; b. Transactional Archive; and c. File Archive. Each of these repositories stores the associated information for all changes detected by the Archive Server.

4. Event initiator allows data on the Archive Server to be available for retrieval utilizing a client and/or may be used to initiate Events. The user specifies what types of data to monitor by configuring the software via a Management Console (not shown) which provides a user interface for possible operation of the Archive Server from the client. The server is configured via the software on the Archive Server. The Archive Server is automatically started after the reboot required upon completion of the software installation or the user may initiate the archive process via the Management Console. The Archive Server monitors specified data sources and detects when changes occur utilizing one or more of the Monitors. When changes are detected, the Archive Server sends all blocks of data (for a new file) or the blocks with changes since the last version (incremental) to the Collector, which then is sent to the appropriate repository on the Archive Server. When a file is deleted from the client, an indicator is set in the Archive File and all data is maintained. Archived data is compressed and encrypted on the Archive Server where it is available for retrieval by the client or for initiating events using Event initiator 4.

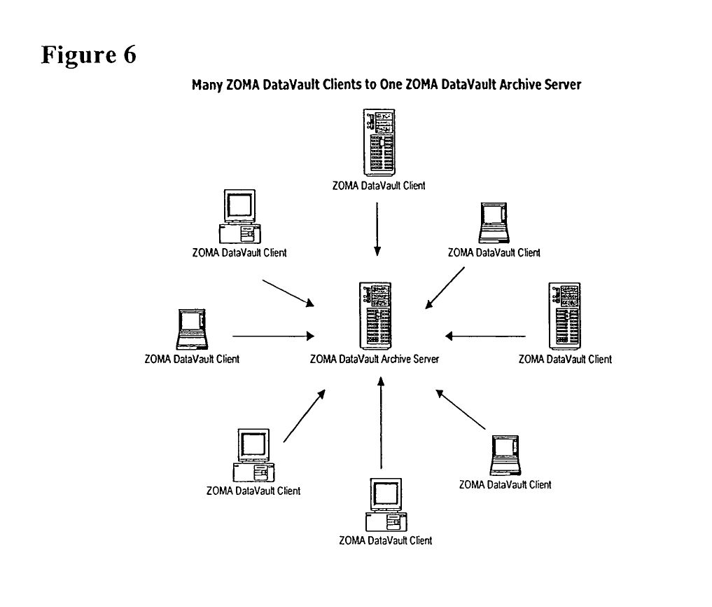

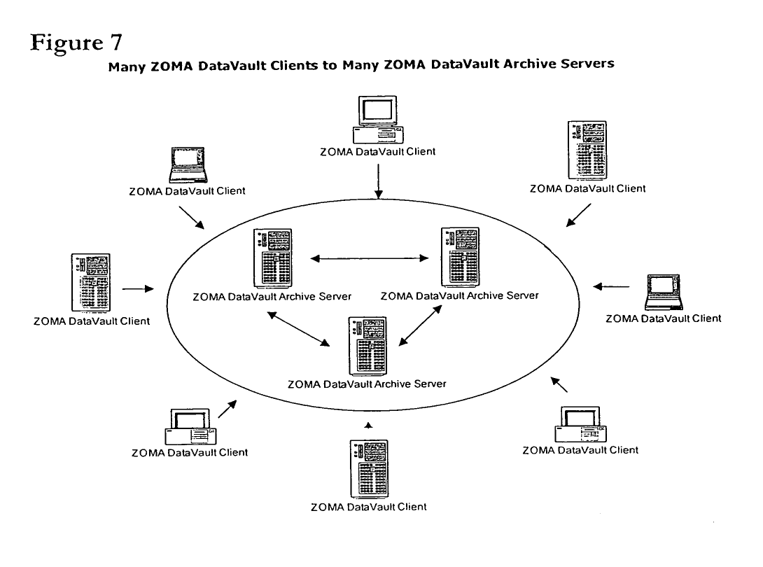

FIGS. 6 and 7 depict the various configurations that can be utilized with the present invention. The following chart outlines the interaction between the client and the Archive Server during the archive process:

| ZOMA DataVault Client | | ZOMA DataVault Server |
|---|---|---|
| Load ZOMA DataVault on client. | | Load ZOMA DataVault on |
| | | Archive Server. |
| Configure client (i.e. specify | | Configure Archive Server. |
| destination Archive Server, | | |
| files/directories to monitor, etc.). | | |
| Initiate monitoring and archiving. | | Initiate Archive Server |
| | | Collector. |
| Change of state detected to | | |
| monitored file/directory. | | |
| Notify Archive Server of change of | [symbol] | Receives notification of change |
| state. | | of state from client. |
| Receives Hash Table from | [symbol] | Sends Hash Table of Archive |
| Archive Server. | | File to client to determine |
| | | changes since previously |
| | | saved version. |
| Compares Hash Table from | | |
| Archive Server to Hash Codes of | | |
| data on client. | | |
| Sends changed blocks of data to | [symbol] | Receives changed blocks from |
| Archive Server compressed and | | client. |
| encrypted. | | |
| | | Updates Archive File with |
| | | changed blocks. |

The following table outlines the interaction between the client and Archive Server during the restore process:

| ZOMA DataVault Client | | ZOMA DataVault Server |
|---|---|---|
| Archive File from Archive Server. | [symbol] | Receives restore request from |
| | | client. |
| Receives requested file from Archive | [symbol] | Sends requested file to client. |
| Server and restores to specified | | |
| location on the client. | | |
| Uncompresses and decrypts | | |
| received data. | | |

Additional features of the invention involves a Method for Archiving and Indexing Data. The DataVault uses a technique for archiving data on the Archive Server that only saves the data that has changed from the last saved version (incremental) and does not require an index to restore. First, the anatomy of an Archive File should be understood.

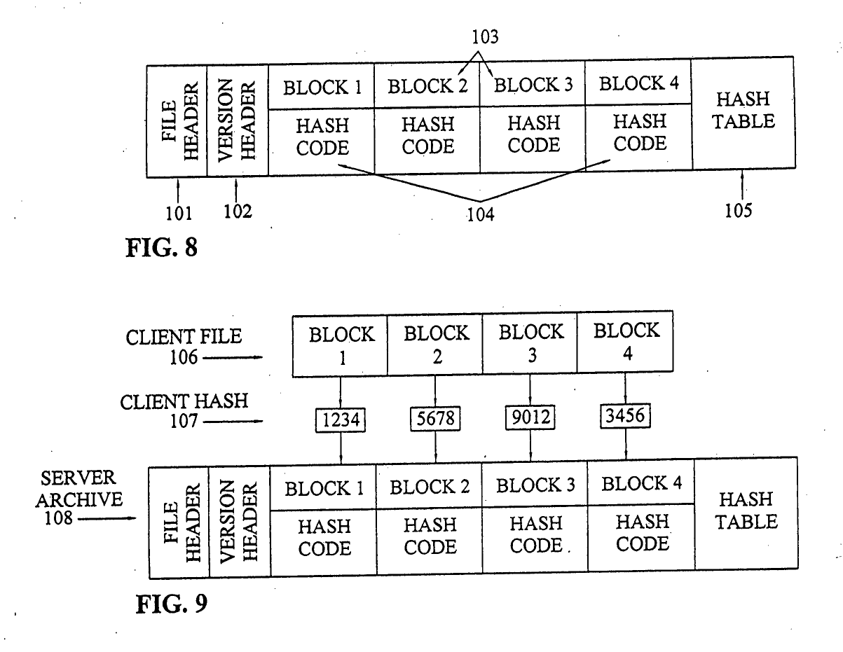

FIG. 8 depicts the Anatomy of an Archive File on the Archive Server. File Header 101 contains attributes about the file. There is only one File Header 101 for each file on the Archive Server. Version Header 102 contains attributes about the version of the file. There is at least one Version Header 102 for each version of the file. Blocks 103 are the blocks of data containing the data from the file (when new) or the changed data from the last archived version (incremental). Hash Code 104 is the associated Hash Code for each block of data in the file. Hash Table 105 is a cross-reference table that contains the most recent Hash Code for each block of data in the file and is used to determine what blocks of data have changed since the last version of the file. There is only one Hash Table for each file on the Archive Server.

The Hashing Method used in the Archive file utilizes an algorithm to generate Hash Codes used to determine when changes to a monitored directory/file occurs, whether it is authorized or unauthorized (tampered). Each file to be archived is separated into blocks of data of variable lengths and a Hash Code is generated for each block based on the uncompressed and unencrypted data contained in the block. The block size is determined by a function of the size of the original file. The algorithm used to determine each block size may vary according to the implementation, for example one implementation may use the size of the uncompressed file divided by 16. All Hash Codes are stored with the associated block of data on the Archive Server. A Hash Table is placed at the end of the file on the Archive Server, which is a compilation of the most recent Hash Codes for each block of data in the file.

When a change is detected by Archive server, the Hash Table for the Archive File is compared to the Hash Codes for each of the blocks in the changed file. Only the blocks with a different Hash Code than the prior version are saved to the Archive Server and appended to the end of the Archive File. Once all changes are sent to the Archive Server, the Hash Table is updated with the latest Hash Codes from the changed blocks and stored at the end of the Archive File.

The method for Detecting Tampered Files proceeds as follows. When the Archive Server detects a change to a monitored file, it compares the Hash Code of the original data to the Hash Code of the changed data. If the Hash Code is changed outside of a certain probability, Archive Server determines how the change occurred and applies rules through the Event Initiator to determine if the file has been tampered. If it is determined that tampering has occurred, the changed blocks are sent to the Archive Server along with the associated Hash Codes. The Archive Server marks the version as tampered in the Version Header and the Hash Table for the file is not updated. This ensures that incremental changes are only based on a non-tampered version of the file.

When restoring a file from the Archive Server to the client, the user may specify if they want to restore tampered versions or if they want to skip tampered versions. If the user decides to skip tampered versions on restore, the Archive Server will omit the Versions with a Tamper Flag set in the Version Header. When a file is deleted on the client, an indicator is set in the File Header of the Archive File on the Archive Server to designate that the file was deleted. The original file and subsequent versions are not deleted from the Archive Server. When restoring a file from the Archive Server to the client, the user may specify if they want to restore a previously deleted file. If the user selects to skip deleted versions on restore, ZOMA DataVault will restore the entire file up to the version specified.

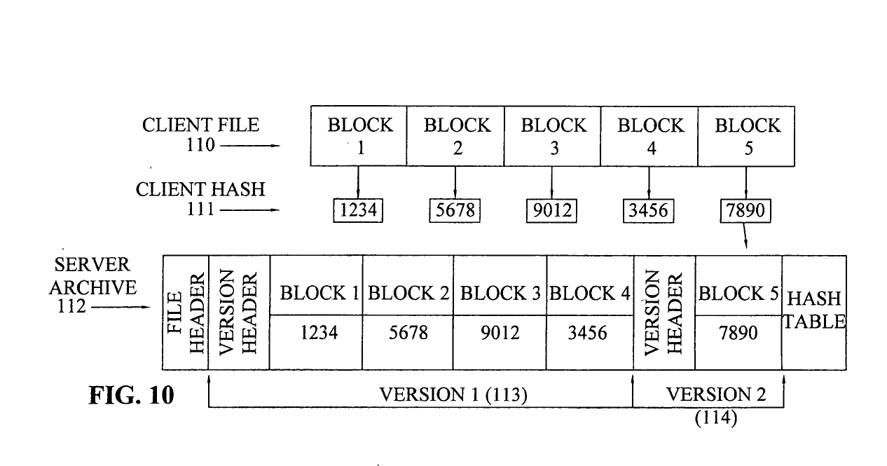

The following scenarios depict how new and modified files are saved to the Archive Server using this method. As FIG. 9 depicts, since client file 106 does not exist on the Archive Server all blocks are sent to the Archive Server along with their associated Hash Codes 107. The Archive Server stores the new data on Server Archive 108 with a File Header, Version Header, Hash Codes for each block of data, and Hash Table for the file.

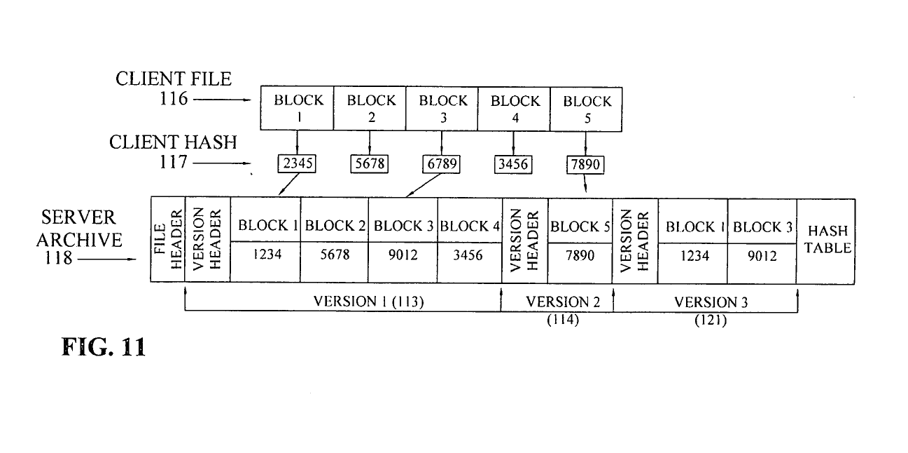

In contrast, when an append to client file 110 is detected, as FIG. 10 depicts, when Hash Code 111 for each block of data on the client is compared to the Hash Table from the Archive Server on Server Archive 112, it is determined that Block 5 is the only data that has changed in the file. Therefore, the client only sends the data from Block 5 along with its associated Hash Code to the Archive Server. The Archive Server appends the data from Block 5 and associated Hash Code 111 to the end of the Server Archive 112 and the Hash Table is updated. Additionally, a Version Header is placed after Block 4 and before Block 5 to indicate that there are now two versions of the file, Version 1 (113) and Version 2 (114).

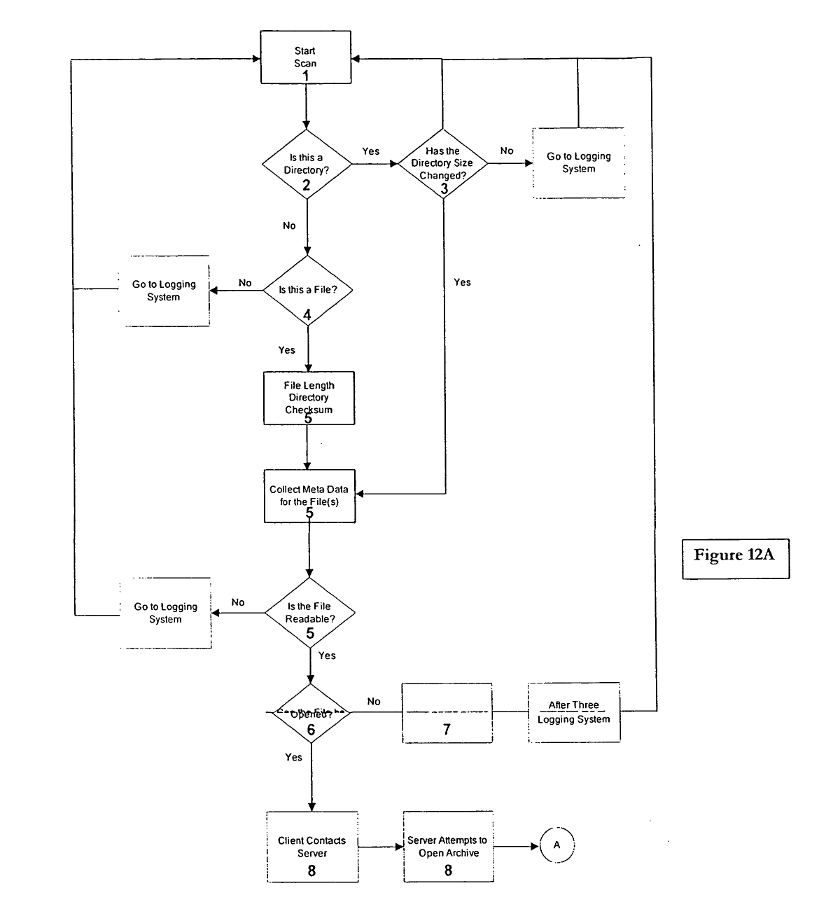

A further scenario is illustrated in FIG. 11, where client file 116 change is detected and only existing data was changed. As FIG. 11 depicts, when Hash Code 117 for each block of data on the client is compared to the Hash Table from Server Archive 118, it is determined that Block 1 and Block 3 are the only ones that changed. Therefore, the client only sends the data from Block 1 and Block 3 along with their associated Hash Codes to the Archive Server. The Archive Server appends the data from Blocks 1 and 3 and their associated Hash Codes to the end of the Archive File at Version 3 (121) and the Hash Table is updated. Additionally, a Version Header is placed after Block 5 and before Block 1 to indicate that there are now three versions of the file, Version 1 (119), Version 2 (120), and Version 3 (121).

Another aspect of the present invention relates to a method for Detecting File/Directory Changes with Scan Methods. Three scan methods may be used by the present invention to determine when changes occur to monitored files/directories. Each method is described below:

Comprehensive Scan—Compares the Hash Code and attributes of all files on the client to the Hash Codes and attributes of all files on the server. All blocks of data are sent to the Archive Server for any file that is new. Any file that contains a Hash Code and/or attribute that does not match is sent to the Archive Server. This scan type is processed on the server side.

Quick Scan—Polls on predetermined interval (as set in the client configuration) and compares the modify date/time of all directories/files on the client with the last scan date/time stored in a file on the client. Any file with a modify date/time greater than the last scan date/time is archived to the Archive Server. This scan type is processed on the client side.

Filesize Checksum Scan—Polls on predetermined interval (as set in the client configuration) and detects changes that occur in a directory by adding together all the file sizes of the directory. If the size changes, then one of the files in that directory has been modified. This scan type is processed on the client side.

Once installed and configured on the client and server, the first process that is initiated is the Comprehensive Scan. This scan method only runs when the Archive Server is initiated for the first time or when manually initiated thereafter by the user. This scan will create the Archive on the Archive Server if it does not exist. Then it compares the Hash Code and attributes of all monitored directories/files on the client to the Hash Code and attributes on the Archive Server. Only the changed blocks of data are archived for any file that contains a Hash Code and/or attribute that does not match. Additionally, if the file does not exist on the Archive Server, all blocks of data are sent to the Archive Server.

Once the Archive is created by the Comprehensive Scan, the Archive Server monitors the client for additions, changes, and deletions utilizing the Quick Scan and Filesize Checksum Scan methods based on a predetermined poll interval set in the client configuration.

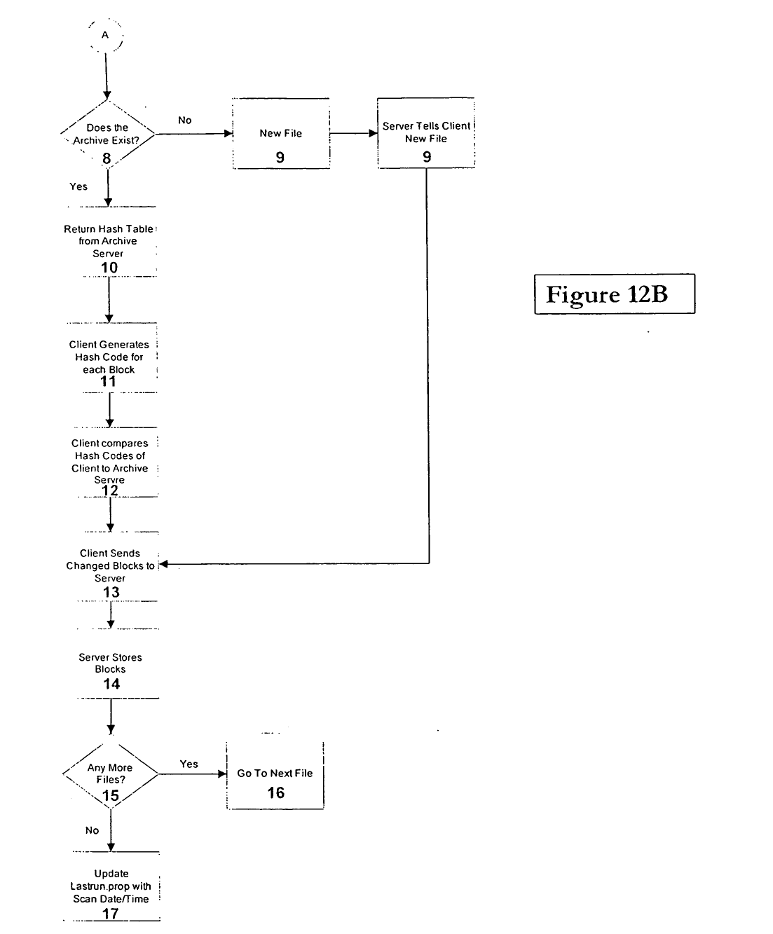

The following outlines the workflow depicted in FIGS. 12A and 12B showing how the present invention detects changes to monitored directories/files and archives the data on the Archive Server utilizing the Quick Scan and Filesize Checksum scan methods outlined above. In step 1, the Quick Scan is initiated on the ZOMA DataVault client based on the poll interval designated in the client configuration file. By comparing the modify date/time of each file and directory to the last scan date/time stored in a file on the client, ZOMA DataVault determines if a change has occurred. In step 2, it determines if the change was in a directory. If the change detected is a directory, then the process checks to determine if the directory size has changed. If the directory size has not changed, then the process goes to the Logging System and the process starts over at step 1 above. In step 3, if the directory size has changed, then all files in the directory are processed starting at step 5 below. If the change is not for a directory then it determines if the change detected is for a file. If the change detected is not for a file, then the process goes to the Logging System and the process starts over at step 1 above. In step 4, If the change detected is for a file, then ZOMA DataVault completes the File Length Directory Checksum and collects the meta data associated with the file such as permissions, link information, resource forks, etc. The process then checks to determine if the changed file is retrievable. If the file is not retrievable, then the process goes to the Logging System and the process starts over at step 1 above. In step 5, If the changed file is readable, then the process checks to determine if the file can be opened.

Next at step 6, If the changed file cannot be opened, then the process will attempt to open the file three additional times. If the process is not successful opening the file after the third attempt, then the process goes to the Logging System and the process starts over at step 1 above. At step 7, if the changed file can be opened, then the client notifies the Archive Server and attempts to open the Archive. The Archive Server determines, in step 8, if the changed file already exists on the Archive Server. If the file does not already exist on the Archive Server in step 9, the Archive Server indicates that it is a new file and notifies the client. If the file already exists on the Archive Server in step 10, the Archive Server sends the Hash Table to the client. Step 11 involves the client generating Hash Codes for each block of data in the changed file.

Then in step 13, the Hash Table from the Archive Server is compared to the Hash Codes of the file on the client. Once the client has determined which blocks have changed in step 14, it sends the changed blocks to the Archive Server. If the file was determined to be new, all blocks of data are sent to the Archive Server. Step 15 then involves the Archive Server storing the blocks of data compressed and encrypted, along with all associated components of the Archive File (i.e.: File Header, Version Header, Hash Table, etc.). Upon completion of step 15, the process determines if there are any more file additions, modifications, or deletions in step 16. If additional files are detected in step 17 as changed, added, or deleted, then the process is repeated starting at step 2 above. Finally, in step 18 ff no additional files are detected as being changed, added, or deleted, then the last scan date/time is updated on the client.

Another aspect of the present invention is the method of Monitor, Collector, and/or Server Interaction. Monitors non-invasively monitor various system and data states. These Monitors send data and meta data from each state of change to a Collector. The key characteristics of Monitors include: (1) Monitors listen for activity in enterprise systems and distributes those discrete changes to a Collector; (2) Utilize a standard IP ASN.1 protocol to communicate between the Monitor and the Collector. ASN.1 is an established standard for agent communications; (3) Monitors data and meta data information on a particular object that is changing. This allows all information to maintain the context in which it was originally used Combining standards-based ASN.1 protocol and an open API (Application Programming Interface), custom and third-party Monitors can easily be created: (4) Encryption, transport compression, and tamper detection are utilized between Monitors and Collectors assuring accurate and efficient transport of information; (5) Open Source Open Adapter Interface allows message bus access to other open standards; (6) Only data and meta data that is needed downstream to the rest of ZOMA is collected. This filtering is configured automatically and significantly reduces the “noise” of data downstream to the CEP (Complex Event Processing) engine.

There are several ways to classify Monitors to collect changes in state. One is a local Monitor which collects data only on the computer on which the Monitor is installed. Another is a Remote Monitor which includes Monitors that are installed on computers in central locations that can remotely monitor multiple systems at the same time. There are two types of Remote Monitors: Passive and Active. A Passive Remote Monitor watches the data stream without intercepting it. An example of a Passive Remote Monitor would be a Log File Monitor that attaches to a server via a network share to monitor its log files. An Active Remote Monitor registers itself with the associated protocol as a recipient of the data. An example of an Active Remote Monitor would be a Monitor that declares itself on the network as a syslogd server where you point servers to this Monitor to receive the messages. Operating system log files, message queues, SOAP messages, etc. are examples of protocols that could either be Passive or Active. If active, they are the recipient of the data—not intercepting it between two sources. Passive Network Packet Capture involves a type of Remote Monitor that passively monitors network packets, decodes them into their associated protocols, and stores the relevant data and meta data. On the other hand, an Operating System Event Monitor is a type of Local Monitor that monitors operating system calls and events in the core of the operating system to determine changes in state.

Collectors communicate with and accept data streams from all Monitors. The Collector sends the changed data and meta data to the Archive Server and dispatches state change information to the Event Server for event initiation. The Collector monitors and corrects any potential tampering of data between Monitors and Collectors by resending the tampered data to the Archive Server again. There are several characteristics of Collectors: (1) Collection of data and meta data from distributed Monitors throughout the enterprise; (2) Many Monitors usually communicate to one Collector; (3) Clustering and failover of Collectors is possible to support load balancing and high availability; (4) The Collector sends collected data and meta data to the Archive Server; and (5) The Collector distributes relevant Events to the CEP engine.

Archive Servers store the data and associated meta data in an effective dated indexed Archive. The Archive Server also responds to requests from Monitors and the a Management Console, including performing search and export functions. In addition, the Archive Server performs a number of routine tasks, such as tamper detection of the Archive, usage reporting and other maintenance functions. The Archive Server is natively architected on an Event-Driven Architecture which uniquely enables processing of “complex events”. There are several characteristics of Archive Servers: (1) Storing file data, transactional data, and meta data in three separate repositories; (2) Archiving retention policies can be used for migration and consolidation of data; (3) Storing only the changed data (incremental), substantially reducing the amount of storage required; (4) Tamper detection is utilized for all Archives preventing any unauthorized changes to archived information; (5) All content is time and content addressable; (6) Coupled with appropriate Monitors and Collectors, Archive Servers provide a point-in-time view with automatic versioning for monitored enterprise assets; and (7) XML (Extensible Markup Language) support allows all data to be accessed in a platform and application independent method. For example, an email archived from a Lotus Notes server can be imported into an Exchange server with most attributes preserved. Initially the Collector extracts meta data from the data sources being monitored to create the Meta Data Archive. Once created, the Collector sends meta data changes to the Meta Data Archive to be updated. Time stamps from meta data changes are recorded allowing for detection of any changes in a database from a specific time and date.

The present invention provides a new method of interaction between such configured Monitors, Collectors, and Servers. Monitors: Network Based Monitors: (1) Read network traffic; (2) Record all network traffic (local host traffic included); and (3) Decode the packet into its original data and meta data form. For example, SQL statements are decoded from capturing network traffic between a database server and a database client. ASN.1 encodes the SQL statements (use the Electronic Interactive Agent specification to create the ASN.1 encoded structure). With this information, the Monitor establishes a socket connection with a Collector; sends the monitored data to the Collector, and continues to send data for every SQL statement coming across the network.

Collectors: (1) Receive a socket connection from the Monitor; (2) Receive data from the Monitor: (3) Close the socket connection and listen for a new connection; (4) ASN.1 decodes the monitor raw data block structure; (5) Record every structure received (data and meta data of collected data); (6) Log optional for all incoming data; (7) Send data and meta data to the Archive Server; and (8) Send message to an event initiator (if used) to initiate events based on the state of changed data.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of reducing information latency in a business enterprise having a computer system, the computer system including a data source, with a change in the data source possibly initiating an event within the computer system, said method comprising the steps of:
accessing the data source and obtaining transaction information relating to changes in the data source; and
determining based on the transaction information if a response to an initiated event is necessary.

2. The method of claim 1 wherein the data source stores data instances and data meta data, wherein said accessing step includes obtaining transaction information indicating a change in at least one of the data instances and data meta data.

3. The method of claim 2 wherein said step of determining includes a step of detecting a threshold change in at least one of the data instances and data meta data.

4. The method of claim 3 wherein said step of detecting includes a step of interpreting the transaction information.

5. The method of claim 4 wherein the transaction information includes a log file.

6. The method of claim 4 wherein the transaction information is obtained through monitoring transactions through a communication channel.

7. The method of claim 4 wherein the transaction information is obtained through changes in a file or directory.

8. The method of claim 4 wherein those network transactions occur between an application and an information source.

9. The method of claim 4 wherein the transaction information is obtained through monitoring transactions.

10. The method of claim 4 wherein the monitored transactions occur between an application and an information source.

11. The method of claim 4 wherein the monitored transactions are reflected in a file or database.

12. The method of claim 4 wherein the monitored transactions are monitored as they pass through a communication device.

13. The method of claim 4 wherein the transaction information includes an action message.

14. The method of claim 2 wherein the step of accessing includes a step of detecting unauthorized transactions relating to changes in the data source.

15. The method of claim 14 wherein the step of detecting unauthorized transactions includes a step of generating a hash based on the data source.

16. A computer system utilizing a communications network comprising:
a plurality of data sources coupled to the communications network;
at least one server coupled to the communications network, said at least one server in communication with said plurality of data sources, at least one of said plurality of data sources storing data in a meta data different than at least one of the other ones of said plurality of data sources, and said at least one server providing access to said plurality of data sources; and
a computer coupled to said at least one server and including a query system for enabling a query to said server relating to data stored in any of said plurality of data sources.

17. The computer system of claim 16 wherein said plurality of data sources includes at least one database or file.

18. The computer system of claim 16 wherein said plurality of data sources includes at least one file.

19. The computer system of claim 16 wherein said plurality of data sources includes at least one application program.

20. The computer system of claim 16 wherein said plurality of data sources includes at least one server.

21. The computer system of claim 16 wherein said query system enables either a user of said computer or an event initiated within the computer system to query said server.

22. The computer system of claim 16 wherein said query system includes a meta data dictionary.

23. A machine-readable program storage device for encoding instructions for a method of reducing information latency in a business enterprise having a computer system, the computer system including a data source, with a change in the data source possibly initiating an event within the computer system, said method comprising the steps of:
accessing the data source and obtaining transaction information relating to changes in the data source; and
determining based on the transaction information if a response to an initiated event is necessary.

24. The machine-readable program storage device of claim 23 wherein the data source stores data instances and data meta data, wherein said accessing step includes obtaining transaction information indicating a change in at least one of the data instances and data meta data.

25. The machine-readable program storage device of claim 24 wherein said step of determining includes a step of detecting a threshold change in at least one of the data instances and data meta data.

26. The machine-readable program storage device of claim 25 wherein said step of detecting includes a step of interpreting the transaction information.

27. The machine-readable program storage device of claim 19 wherein the transaction information includes a log file.

28. The machine-readable program storage device of claim 27 wherein the transaction information includes an action message.

29. The machine-readable program storage device of claim 23 wherein the step of accessing includes a step of detecting unauthorized transactions relating to changes in the data source.

30. The machine-readable program storage device of claim 29 wherein the step of detecting unauthorized transactions includes a step of generating a hash based on the data source.

31. A collector for a computer system utilizing a communications network comprising:
at least one server coupled to the communications network, said at least one server in communication with a plurality of data sources, and said at least one server providing access to messages being transmitted into the plurality of data sources; and
a computer coupled to said at least one server and including a monitoring system for observing the messages being transmitted into in any of said plurality of data sources, said computer including detection logic for identifying unauthorized transactions included in the messages.

32. The collector of claim 31 wherein said monitoring system is adapted to monitor electronic mail messages.

33. The collector of claim 31 wherein said monitoring system is adapted to monitor instant text messages.

34. The collector of claim 31 wherein said monitoring system is adapted to monitor voice over internet protocol (VoIP) messages.

35. A method of archiving data comprising the steps of:
maintaining at least one data set in a data storage having a plurality of data records;
determining the existence of change in any of the plurality of data records; and
updating only the data records determined to have a change.

36. The method of claim 35 wherein each of the data records has an associated hash value, and the step of determining utilizes the associated hash value.

37. The method of claim 1 wherein said step of determining is performed asynchronously based on an internal clock.

38. The method of claim 1 wherein said step of accessing is performed by monitoring transactions to and from the data source.

39. The collector of claim 31 wherein said monitoring system includes an internal clock so that the identifying may be accomplished asynchronously.
